(19) United States
(12) Patent Application Publication
(10) Pub. No.: US 2022/0270815 A1
(43) Pub. Date: Aug. 25, 2022

(54) INSULATION MEMBER

(71) Applicant: Hitachi Energy Switzerland AG, Baden (CH)

(72) Inventors: Miguel Cuesto, Cordoba (ES); Sergio Larrubia, Cordoba (ES); Manuel Vaquero, Cordoba (ES)

(21) Appl. No.: 17/631,514

(22) PCT Filed: Oct. 6, 2020
(86) PCT No.: PCT/EP2020/077997

§ 371 Date: Jan. 31, 2022

(30) Foreign Application Priority Data
Oct. 7, 2019 (EP) 19382871.2

(51) Int. Cl. H01F 27/32

(52) U.S. Cl. CPC H01F 27/322

(57) ABSTRACT

An insulation member for being arranged adjacent to a transformer coil is provided. The insulation member includes a flat base including a first half and a second half defined along a symmetry plane and a plurality of discrete spacers projecting from the plane of the base. The spacers are attached to the first and second halves for allowing a cooling fluid to circulate between the coil and the flat base. The first half includes at least four zones, each zone having spacers arranged according to a predetermined orientation with respect to an orientation axis. The orientation of spacers between adjacent zones is different. The spacers at a first zone are oriented at an angle of between 120-150 degrees, in a second zone at between 80-100 degrees, in a third zone at between 30-60 degrees, and in a fourth zone between 120-150 degrees.

### CROSS REFERENCE TO RELATED APPLICATIONS

This application is a 35U.S.C. § 371national stage application of PCT International Application No. PCT/EP2020/077997filed on Oct. 6, 2020, which in turns claims foreign priority to European Patent Application No. 19382871.2, filed on Oct. 7, 2019, the disclosures and content of which are incorporated by reference herein in their entirety.

The present disclosure is related to insulation members, more specifically to insulation members for transformers.

### BACKGROUND ART

In order to cool down a transformer it is known to use cooling systems. Some cooling systems use a cooling fluid such as mineral oil or cooled air to remove the heat produced by the coil windings.

The use of insulating members arranged between coils of a transformers is known. Such insulation members usually comprise projecting portions to space apart the insulation member from the coil thereby allowing the cooling fluid to circulate between both elements. The transformer may thus be more effectively cooled down.

Certain parts of the coil may, however, not be effectively cooled down, e.g. in areas in the proximity of the outlet point of the cooling fluid where the cooling fluid is at its maximum temperature, i.e. after removing at least part of the heat produced by the windings. Indeed, in downstream areas/points, the cooling fluid has a higher temperature as the cooling fluid is progressively heated as it flows through the windings.

In addition, when a cooling fluid is used, the transformers usually require a pump in order to force the circulation of the cooling fluid. The use of pumps involves several drawbacks, such as an increased maintenance and manufacturing costs, more complex assembling process, etc. Furthermore, in some cases, e.g. if auxiliary power is lost, the pumps would not work, therefore the transformer would either not be able to operate or the operating power of the transformer would need to be reduced, which leads to a less reliable transformer.

In conclusion, it would be desirable to provide an insulation member which is easy and cost effective to manufacture while at the same time improves the heat removal efficiency and which reduces the maintenance costs of a transformer.

### SUMMARY

An insulation member for being arranged adjacent to a transformer coil is provided. The insulation member comprises a flat base comprising a first half and a second half defined along a symmetry plane and a plurality of discrete spacers projecting from the plane of the base. The spacers are attached to the first half and the second half for allowing a cooling fluid to circulate between the coil and the flat base. The first half comprises at least four zones, each zone having a plurality of spacers arranged according to a predetermined orientation with respect to an orientation axis on the plane of the flat base and perpendicular to the symmetry plane. The orientation of spacers between adjacent zones is different. A first zone comprises a plurality of spacers at an angle of between 120-150 degrees with respect to the orientation axis, a second zone comprises a plurality of spacers oriented at an angle of between 80-100 degrees with respect to the orientation axis, a third zone comprises a plurality of spacers oriented at an angle of between 30-60 degrees with respect to the orientation axis and a fourth zone comprises a plurality of spacers oriented at an angle of between 120-150 degrees with respect to the orientation axis. The first, second, third and fourth zones are arranged successively on the flat base from the symmetry plane to the orientation axis.

In an example, at least 60% of the spacers in each zone may be arranged according to the predetermined orientation.

In an example, the orientation of the spacers in the second half may be symmetrical to the orientation of the spacers of the first half with respect to the symmetry plane.

In an example, the spacers may be rectangular, triangular, circular, elliptical, S-shaped or a combination thereof in order to further enhance or promote the circulation of the cooling fluid.

In an example, the spacers may be arranged at both sides of the flat base. As a result, a single insulation member may be arranged between two adjacent transformer coils, and thus, the number of insulation members may be reduced. A less bulky transformer having low manufacturing costs may therefore be obtained.

In an example, the flat base may be made of cardboard. In an example, the spacers may be or may not be made of the same material of the flat base.

In a further aspect, a transformer is provided. The transformer comprises a magnetic core, a coil around the magnetic core and a pair of insulation members according to any of the disclosed examples for being arranged at both sides of the coil. In an example, the transformer may be a shell-type. In another example, the transformer may be a core-type transformer.

### BRIEF DESCRIPTION OF THE DRAWINGS

Particular embodiments of the present device will be described in the following by way of non-limiting examples, with reference to the appended drawings, in which:

FIG. 1 schematically illustrates an insulation member according to an example;

FIG. 2 schematically illustrates a first half of an insulating member according to an example;

FIG. 3 schematically illustrates the active part of a transformer according to an example; and

FIG. 4 schematically illustrates a simplified lateral view of a transformer according to an example.

### DETAILED DESCRIPTION

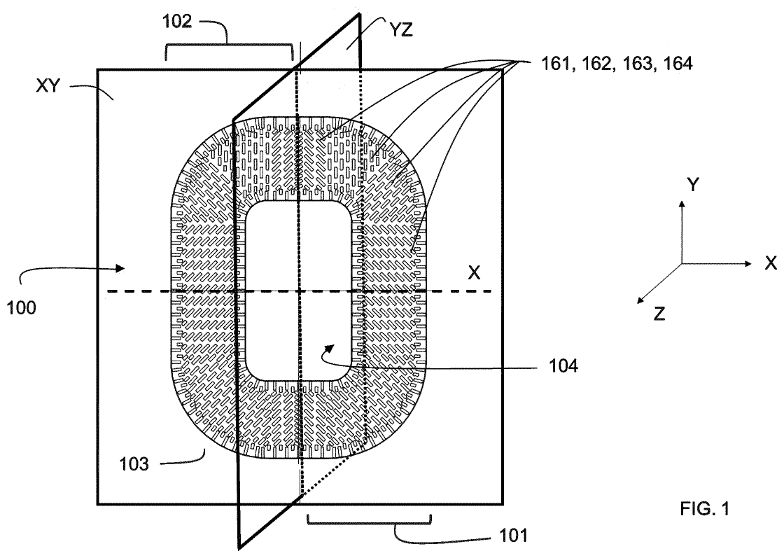

FIG. 1 depicts an insulation member 100 that may be arranged adjacent to a transformer coil according to an example. The insulation member 100 may comprise a flat base 103 defining a plane XY, i.e. the plane of the base, and a plurality of discrete spacers 161, 162, 163, 164 arranged on the flat base.

The flat base 103 may comprise a first half 101 and a second half 102 that may be defined along a symmetry plane YZ which may be perpendicular to the plane XY of the base. The flat base 103 may be made of an insulating material, e.g. cellulose based carboard, aramid based insulating material, etc; and its dimensions may depend on the size of the coil i.e. of the transformer. The surface of the flat base may, in an example, substantially correspond to the surface of the adjacent coil.

The flat base 103 may comprise a central hollow portion or window 104 for the magnetic core of the transformer e.g. a shell-form transformer. In an example, the flat base may be a rounded rectangle. In other examples, the flat base may be a rectangle with rounded edges. In a further example, the flat base may be elliptical. In cases where the transformer is a core-form transformer the shape of the base may be cylindrical.

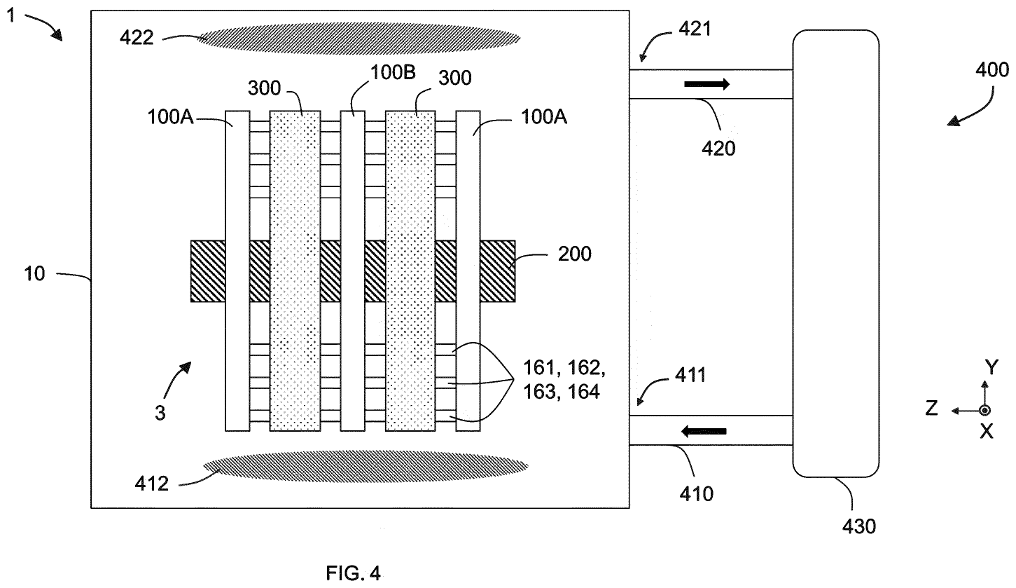

The flat base 103 may be part of a transformer that may comprise a fluid-based cooling system having an inlet point and an outlet point where the fluid is respectively introduced and removed. The flat base may thus comprise two areas located respectively close, i.e. in the proximity, to the inlet and outlet points of the cooling fluid (see FIG. 4).

The spacers 161, 162, 163, 164 may attached to the first and second halves 101, 102 e.g. by adhesive or by any other suitable method, and may projected from the plane XY of the base. The spacers 161, 162, 163, 164 enable spacing apart the flat base, i.e. the insulating member, from an adjacent coil of the transformer. A cooling fluid may therefore be allowed to circulate between both elements i.e. the flat base of the insulating member and the coil.

The spacers 161, 162, 163, 164 may be made of an insulating material that may be or may not be equal to the material of the flat base. In an example, the spacers may be made of cardboard. In another example, the spacers may be made of synthetic insulating material e.g. aramid based insulation material.

The spacers 161, 162, 163, 164 may be shaped to improve the flow of the cooling fluid. The spacers may be rectangular, triangular, circular, elliptical, S-shaped or a combination thereof. In an example, the spacers 161, 162, 163, 164 may be rectangular blocks of about 80×25×6 mm.

The spacers 161, 162, 163, 164 may be attached to the side(s) of the flat base facing a coil. That is, in cases where the insulating member 100 is to be arranged adjacent to a single coil, the spacers may be arranged at least at the side of the insulating member facing the coil. Besides, when the insulating member 100 is to be arranged between two successive coils, i.e. having each side facing a coil, the spacers may be arranged at both sides of the insulating member for enabling spacing apart the insulating member from each coil.

The spacers 161, 162, 163, 164 may be arranged at least on the first half 101 of the base according to a predetermined orientation thereby defining different zones (see FIG. 1).

Such predetermined orientation may be with respect to an orientation axis X on the plane of the flat base and perpendicular to the symmetry plane XY. The first half 101 may therefore comprise different zones. Each zone may comprise a plurality of spacers arranged according to a predetermined orientation which may be different between adjacent zones

In an example, at least the 60% of the spacers in each zone may be oriented at the predetermined orientation. In an example, at least the 75% of the spacers in each zone may be oriented at the predetermined orientation.

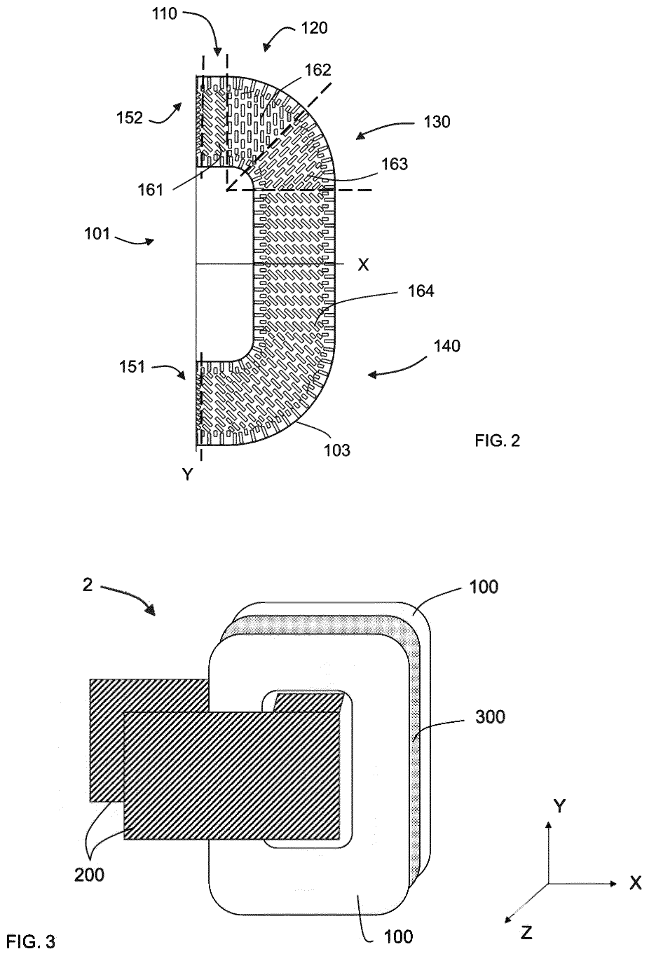

FIG. 2 shows the first half 101 of the flat base 103 of FIG. 1 comprising four different zones 110, 120, 130, 140.

The first zone 110 may comprise a plurality of spacers 161 at an angle of between 120-150 degrees, more particularly at about 135 degrees, with respect to the orientation axis X.

The second zone 120 may comprise a plurality of spacers 162 at an angle of between 80-100 degrees, more particularly at about 90 degrees, with respect to the orientation axis X.

The third zone 130 may comprise a plurality of spacers 163 at an angle of between 30-60 degrees, more particularly at about 45 degrees, with respect to the orientation axis X.

The fourth zone 140 may comprise a plurality of spacers 164 at an angle of between 120-150 degrees, more particularly at about 135 degrees, with respect to the orientation axis. The surface of the fourth zone 140 may cover at least the 50% of the first half 101 of the flat base.

By using an insulation member comprising at least four zones and having the spacers oriented as claimed, the local speed of the cooling fluid may be increased and the auto-circulation of the cooling fluid may be promoted. The convective heat transference may therefore be enhanced and so, the coil areas having more elevated temperatures may be more efficiently cooled down. A more effective cooling may thus be obtained which results in a safer and more secure transformer (in operation).

For example, it may be desirable to have the proper succession and coordination between the four zones. For example, any change on any of the depicted zones would have influence in the following zone and ultimately in the cooling results.

The succession among the first, second, third and fourth zones may provide specific benefits. For example, one technical reason is that the cooling fluid will be changing its basic parameters (temperature, velocity, direction and pressure drop) depending on the design of the spacers within each zone and depending on the transition between one zone to the following zone.

For example, if the design of the solution of spacers in the first zone is in such a way that the pressure drop is very high, the velocity with which the fluid will arrive to the second zone and the result on the temperatures would be completely different (higher in this case due to lower velocity and consequent worse convective effect) compared to a first zone where the pressure drop is lower.

In addition, as the circulation of the cooling fluid is enhanced and/or promoted due to the claimed orientation of the spacers, cooling fluids of different densities and/or viscosities may be used e.g. air, mineral oil, biodegradable fluids such as esters which are more environmentally friendly, etc. A more versatile and/or eco-friendly transformer may therefore be obtained. Furthermore, as no pumps are required to force the circulation of the fluid, the energy consumption and maintenance costs of the resulting transformer may be reduced.

By using a spacer arrangement according to any of the disclosed examples the cooling fluid may be directed to the inner side of the coil i.e. adjacent to the internal window of the magnetic core, where the fluid velocity is usually lower, and thus, the fluid may be kept moving which promotes the auto-circulation and/or improves its circulation.

In the example of FIG. 2, the first zone 110, the second zone 120, the third zone 130 and the fourth zone 140 may be successively arranged on the flat base from the symmetry plane XY to the orientation axis X. In other examples, different arrangement of the zones may be defined. As long as the orientation of spacers in successive or adjacent zones is different the flat base may comprise any number of zones e.g. five zones.

In an example, the flat base 103 may comprise at least a transition zone 151, 152 between the first half and the second half. A first transition zone 151 may be located in the proximity of an inlet point area 412 of the cooling fluid i.e. the area where the cooling fluid is at the lowest temperature (see FIG. 4). The spacers on the first transition zone 151 (partially shown in FIG. 2) may be oriented at about 120-140 degrees, more particularly at about 135 degrees, with respect to the orientation axis X.

The flat base may further comprise a second transition zone 152 located in the proximity of the outlet point area 422 (see FIG. 4). The spacers of the second transition zone 152 may be oriented at 30-50 degrees, more particularly at 45 degrees, with respect to the orientation axis X, the symmetrical behaviour of the cooling fluid between inlet and outlet points may therefore be facilitated.

For the sake of clarity FIG. 2 only depicts a first half 101 of the flat base. The orientation of the spacers 161, 162, 163, 164 in the second half 102 of the flat base may, in an example, be symmetrical to the orientation of the spacers of the first half 101 with respect to the symmetry plane XY (see FIG. 1). The resulting insulating member increases the local speed of the fluid, and the heat from the windings may be more effectively removed. In addition, no pumps or smaller pumps are required to force the circulation of a cooling fluid, which reduce the maintenance costs of the transformer, enables different density cooling fluids to be used and also provides a more versatile transformer which may function with pump free cooling systems.

In cases where the insulation member comprises spacers arranged at both sides of the flat base, the orientation of the spacers and/or the arrangement of the zones may be the same at both sides.

FIG. 3 shows an exemplary and simplified active part 2 of a transformer, e.g. a shell-type or a core-type transformer, comprising two insulation members 100 according to any of the disclosed examples enclosing a coil 300, and a magnetic core 200 passing through them. Although for the sake of clarity only two insulating members and a single coil are depicted, the number of coils and insulating members in the active part of a transfer may vary, e.g. depending on the size and/or the generated voltage. For instance, a 400 kV transformer may comprise around 40 coils. Besides, a 132 kV transformer may comprise 20 coils.

In FIG. 3, the active part 2 of a transformer may comprise a plurality of coils having an insulation member between adjacent coils i.e. each side of the insulation member would face a coil. In addition, a pair of insulating members may be arranged adjacent to the coils at both ends i.e. having a single side facing a coil. The insulating member(s) may be adhered to a coil e.g. by pressure.

FIG. 4 depicts a simplified and very schematic side view of a transformer 1, e.g. a shell-type or a core-type transformer, comprising an active part 3 housed within a tank 10. The active part 3 of the transformer of the example comprises two coils 300 and three insulation members 100A, 100B but any other number may be used as long as there is at least one insulating member 100A, 100B more than the number of coils 300 for enclosing the windings. That is, the elements of the active part of the transformer, i.e. the coils and the insulating members, may be arranged alternatingly. In an example, a pair of insulating members may be arranged at respective ends of the active part, i.e. the first and last elements may be insulating members.

The insulating member(s) 100B arranged between two successive coils 300 may have spacers arranged at both sides of the flat surface. The insulating members 100A arranged at both ends of the active part 3, i.e. the insulation members having a single side facing a coil, may comprise spacers 161, 162, 163, 164 only at the side facing the coil. In an alternative example, all insulating members 100A, 100B of the active part 3 may comprise spacers arranged at both sides of the flat base.

The transformer of FIG. 4 may further comprise a fluid-based cooling system 400 having an inlet point 411 and an outlet point 421 from which the fluid may be respectively introduced and removed from the tank 10 where the active part of the transformer is located. The transformer may comprise an inlet area 412 and an outlet area 422 in the proximity of the inlet point 411 and the outlet point 421, respectively. Once in operation, the cooling fluid in the outlet area 422 may be warmer than the fluid in the inlet area i.e. as consequence of removing the heat from the coils.

The fluid of the cooling system may be e.g. mineral oil, air, biodegradable fluids such as esters or any other suitable fluid.

The cooling system 400 may comprise a heat exchanger 430 to which a feeding pipe 410 for inputting a cooling fluid into the transformer tank, and a return pipe 420 for outputting the heated water from the windings of the transformer may be coupled. A cooling circuit for the flow of a cooling fluid may therefore be formed i.e. the cooled cooling fluid may flow from the heat exchanger 430 to the feeding pipe 410 (see the arrow) and then into the tank 10 where it may flow between the coils 300 and the insulation members 100A, 100B; and finally to the return pipe 420 which directs the fluid back to the heat exchanger 430 (see the arrow).

The feeding pipe 410 and the return pipe 420 may be coupled to the transformer tank 10 at inlet point 411 and at outlet point 421, respectively. When the cooling fluid is input in the tank at the inlet point 411, its temperature is the coldest of the circuit and, as the fluid is warmed, i.e. when the heat from the windings is removed, a density loss occurs which promotes a flow of the cooling fluid from the inlet point to the outlet point. Moreover, the orientation at which the spacers are arranged in insulating members 100A, 100B, according to any of the disclosed examples, improve the circulation of the fluid which further enhances or promotes an auto-circulation of the cooling fluid i.e. no pump is required to force the cooling fluid to circulate.

Therefore, a transformer comprising insulating members according to any of the disclosed examples may comprise a cooling system that may not require pumps or may require smaller pumps for forcing the cooling fluid to flow. The manufacturing and maintenance costs of such transformer may therefore be reduced as less elements may be required for the functioning of the transformer. The assembling difficulty may also be reduced as no pump is required.

In some examples, the cooling system 400 may comprise a pump (not shown) in order to further force the circulation of the cooling fluid.

That is, the orientation of the spacers facilitates the flow of the cooling fluid, and so a transformer comprising insulating members according to any of the disclosed examples may have either a natural cooling system, i.e. pump free, or a directed cooling system.

In an example, the cooling system may be oil natural (ON) that is the cooling fluid may be (mineral) oil and no pump is required to force the flow of oil. In an example, the cooling system may be air natural (AN). In an example, the cooling system may be oil directed (OD). In an example, the cooling system may be air force (AF).

Although in the examples of the FIGS. 3 and 4, the insulation members and the coil are arranged vertically along XY plane, in other examples (not shown), the insulation members 100, 100A, 100B and the coils 300 may be arranged horizontally along the plane XZ.

Although only a number of particular embodiments and examples have been disclosed herein, it will be understood by those skilled in the art that other alternative embodiments and/or uses of the disclosed innovation and obvious modifications and equivalents thereof are possible. Furthermore, the present disclosure covers all possible combinations of the particular embodiments described. The scope of the present disclosure should not be limited by particular embodiments, but should be determined only by a fair reading of the claims that follow.

1. An insulation member for being arranged adjacent to a transformer coil, the insulation member comprising:
a flat base comprising a first half and a second half defined along a symmetry plane,
a plurality of discrete spacers projecting from the plane of the base, the spacers being attached to the first half and the second half for allowing a cooling fluid to circulate between the coil and the flat base, the first half comprising at least four zones, each zone having a plurality of spacers arranged according to a predetermined orientation with respect to an orientation axis on the plane of the flat base and perpendicular to the symmetry plane, an orientation of spacers between adjacent zones being different, and
the at least four zones comprising:
a first zone comprising a plurality of spacers at an angle of between 120-150 degrees with respect to the orientation axis;
a second zone comprising a plurality of spacers oriented at an angle of between 80-100 degrees with respect to the orientation axis;
a third zone comprising a plurality of spacers oriented at an angle of between 30-60 degrees with respect to the orientation axis; and
a fourth zone comprising a plurality of spacers oriented at an angle of between 120-150 degrees with respect to the orientation axis,
the first, second, third and fourth zones being arranged successively on the flat base from the symmetry plane to the orientation axis.

2. The insulation member according to claim 1, wherein at least 60% of the spacers in each zone are arranged according to the predetermined orientation.

3. The insulation member according to claim 1, wherein the spacers of the first zone are arranged at about 135 degrees with respect to the orientation axis, the spacers of the second zone are arranged at about 90 degrees with respect to the orientation axis, the spacers of the third zone are arranged at about 45 degrees with respect to the orientation axis and the spacers of the fourth zone are arranged at about 135 degrees with respect to the orientation axis.

4. The insulation member according to claim 1, wherein an orientation of the spacers in the second half is symmetrical to the orientation of the spacers of the first half with respect to the symmetry plane.

5. The insulation member according to claim 1, further comprising between first half and second half, a first transition zone at an inlet area and a second transition zone at an outlet area.

6. The insulation member according to claim 5, wherein the spacers are oriented about 35 degrees with respect to the orientation axis at the first transition zone and about 125 degrees with respect to the orientation axis at the second transition zone.

7. The insulation member according to claim 1, wherein a surface of one of the zones covers at least 50% of a surface of the first half.

8. The insulation member according to claim 1, wherein the insulation member is a substantially rounded rectangle and comprises a central hollow portion for allowing at least part of a transformer core to go through.

9. The insulation member according to claim 1, wherein the spacers are at least one of rectangular, triangular, circular, elliptical, S-shaped, and a combination thereof.

10. The insulation member according to claim 1, wherein the spacers are arranged at both sides of the flat base.

11. The insulation member according to claim 1, further comprising a plurality of spacers at a periphery of the flat base gradually varying their orientation with respect to the orientation axis.

12. The insulation member according to claim 1, wherein the flat base is made of cardboard.

13. A transformer comprising:
a magnetic core,
a coil around the magnetic core having a first side and a second side, and
a pair of insulation members according to claim 1 arranged at both sides of the coil, each insulation member comprising:
a flat base comprising a first half and a second half defined along a symmetry plane,
a plurality of discrete spacers projecting from the plane of the base, the spacers being attached to the first half and the second half for allowing a cooling fluid to circulate between the coil and the flat base, the first half comprising at least four zones, each zone having a plurality of spacers arranged according to a predetermined orientation with respect to an orientation axis on the plane of the flat base and perpendicular to the symmetry plane, an orientation of spacers between adjacent zones being different, and
the at least four zones comprising:
a first zone comprising a plurality of spacers at an angle of between 120-150 degrees with respect to the orientation axis;
a second zone comprising a plurality of spacers oriented at an angle of between 80-100 degrees with respect to the orientation axis;
a third zone comprising a plurality of spacers oriented at an angle of between 30-60 degrees with respect to the orientation axis; and
a fourth zone comprising a plurality of spacers oriented at an angle of between 120-150 degrees with respect to the orientation axis,
the first, second, third and fourth zones being arranged successively on the flat base from the symmetry plane to the orientation axis.

14. The transformer according to claim 13, wherein the insulation members are joined at each side of the coil by pressure.

15. The transformer according to claim 13, wherein, for each insulation member, at least 60% of the spacers in each zone are arranged according to the predetermined orientation.

16. The transformer according to claim 13, wherein, for each insulation member, the spacers of the first zone are arranged at about 135 degrees with respect to the orientation axis, the spacers of the second zone are arranged at about 90 degrees with respect to the orientation axis, the spacers of the third zone are arranged at about 45 degrees with respect to the orientation axis and the spacers of the fourth zone are arranged at about 135 degrees with respect to the orientation axis.

17. The transformer according to claim 13, wherein, for each insulation member, an orientation of the spacers in the second half is symmetrical to the orientation of the spacers of the first half with respect to the symmetry plane.

18. The transformer according to claim 13, further comprising, for each insulation member, between first half and second half, a first transition zone at an inlet area and a second transition zone at an outlet area.

19. The transformer according to claim 18, wherein, for each insulation member, the spacers are oriented about 35 degrees with respect to the orientation axis at the first transition zone and about 125 degrees with respect to the orientation axis at the second transition zone.

20. A method comprising:
arranging a pair of insulation members at opposite ends of a coil disposed around a magnetic core of a transformer, each insulation member comprising:
a flat base comprising a first half and a second half defined along a symmetry plane,
a plurality of discrete spacers projecting from the plane of the base, the spacers being attached to the first half and the second half for allowing a cooling fluid to circulate between the coil and the flat base, the first half comprising at least four zones, each zone having a plurality of spacers arranged according to a predetermined orientation with respect to an orientation axis on the plane of the flat base and perpendicular to the symmetry plane, an orientation of spacers between adjacent zones being different, and
the at least four zones comprising:
a first zone comprising a plurality of spacers at an angle of between 120-150 degrees with respect to the orientation axis;
a second zone comprising a plurality of spacers oriented at an angle of between 80-100 degrees with respect to the orientation axis;
a third zone comprising a plurality of spacers oriented at an angle of between 30-60 degrees with respect to the orientation axis; and
a fourth zone comprising a plurality of spacers oriented at an angle of between 120-150 degrees with respect to the orientation axis,
the first, second, third and fourth zones being arranged successively on the flat base from the symmetry plane to the orientation axis; and applying pressure to the pair of insulation members to join the insulation members to the coil.
